(19) United States
(12) Patent Application Publication
(10) Pub. No.: US 2014/0184537 A1
(43) Pub. Date: Jul. 3, 2014

(54) TOUCH CONTROL DEVICE AND TOUCH CONTROL PROCESSING METHOD

(71) Applicant: ASUSTek COMPUTER INC., Taipei (TW)

(72) Inventors: Hsih-Sung HSU, TAIPEI (TW); Meng-Ju LU, TAIPEI (TW)

(73) Assignee: ASUSTek COMPUTER INC., Taipei (TW)

(21) Appl. No.: 14/108,308

(22) Filed: Dec. 16, 2013

(30) Foreign Application Priority Data
Dec. 27, 2012 (CN) 201210579699.2

(51) Int. Cl. G06F 3/0488

(52) U.S. Cl. CPC G06F 3/04883
USPC 345/173

(57) ABSTRACT

A touch control device comprises a touchpad, a display unit and a processing unit. The touchpad detects a touch gesture and generates information corresponding to the touch gesture. The processing unit includes a page display module, a gesture processing engine, a gestures determining module and a control module. The gesture processing engine determines whether the information corresponding to the touch gesture includes the information of at least three fingers touch the touchpad. The gestures determining module determines whether the touchpad detects a scrolling gesture made by one of the fingers when the information corresponding to the touch gesture includes the information of at least three fingers touch the touchpad. The control module scrolls the page or image displayed on the display unit according to the scrolling gesture when the touchpad detects the scrolling gesture made by at least one of the fingers.

### CROSS-REFERENCE TO RELATED APPLICATION

This application claims the priority benefit of China application serial No. 201210579699.2, filed on Dec. 27, 2012. The entirety of the above-mentioned patent application is hereby incorporated by reference herein and made a part of specification.

### BACKGROUND OF THE INVENTION

1. Field of the Invention

The disclosure relates to a touch control device and a touch control processing method and, more particularly, to a multi-touch control device and multi-touch control processing method.

2. Description of the Related Art

Users can operate an electronic device by a touchpad to execute touch control function. When users want to scroll a page on a display unit, the gesture of a single finger or two fingers is utilized to perform the control.

However, when operating on the touchpad by a single finger for scrolling, users can only operate in a limited area near the edge of a touchpad so that the position of the gesture operation is limited. Meanwhile, users cannot freely place their wrists. In addition, their wrists have to move along with the gesture of two fingers without any supporter while operating the touchpad which cause wrist fatigue, furthermore, the gesture is inconvenient to browse the website for a long time.

### BRIEF SUMMARY OF THE INVENTION

A touch control device that can be operated by three or more fingers is provided. The touch control device includes a touchpad, a display unit and a processing unit. The processing unit is electrically connected to the touchpad and the display unit. The touchpad detects a touch gesture and generates information corresponding to the touch gesture. The processing unit includes a page display module, a gesture processing engine, a gestures determining module and a control module. The page display module drives the display unit to display a page. The gesture processing engine determines whether the information corresponding to the touch gesture includes the information of at least three fingers touch the touchpad. The gestures determining module determines whether the touchpad detects a scrolling gesture made by one of the fingers when the information corresponding to the touch gesture includes the information of at least three fingers touch the touchpad. The control module scrolls the page or image displayed on the display unit according to the scrolling gesture when the touchpad detects the scrolling gesture made by at least one of the fingers.

A touch control processing method applied to a touch control device is also provided. The touch control device comprises a touchpad and a display unit, and the touch control processing method comprises the following steps:

(a) detecting a touch gesture via the touchpad and generating information corresponding to the touch gesture;

(b) determining whether the information corresponding to the touch gesture includes at least three fingers touch the touchpad;

(c) determining whether the touchpad detects a scrolling gesture made by one of the fingers when the information corresponding to the touch gesture includes the at least three fingers touch the touchpad; and

(d) scrolling the page or image displayed on the display unit according to the scrolling gesture when the touchpad detects the scrolling gesture made by at least one of the fingers

Since at least two other fingers support the hand when one finger makes the scrolling gesture, wrist fatigue is reduced even the scrolling gesture lasts for a long time.

### BRIEF DESCRIPTION OF THE DRAWINGS

FIG. 1 is a functional block diagram showing a touch control device in an embodiment.

FIG. 2 is an embodiment showing that three fingers operate the touch control device in an embodiment.

FIG. 3 is a flow diagram showing a touch control processing method applied in a touch control device in an embodiment.

### DETAILED DESCRIPTION OF THE EMBODIMENTS

These and other features, aspects, and advantages of the present disclosure will become better understood with regard to the following description, appended claims, and accompanying drawings. Persons having ordinary skill in the art may make various modifications and changes without departing from the scope and spirit of the disclosure.

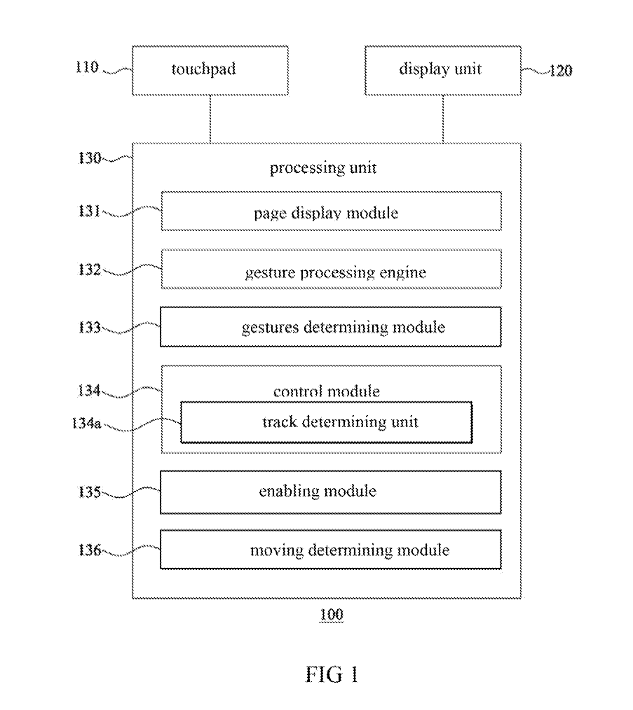

FIG. 1 is a functional block diagram showing a touch control device in an embodiment. The touch control device can provide the function that the touch control operation is operated by a three or more-finger gesture.

A touch control device 100 includes a touchpad 110, a display unit 120 and a processing unit 130. The processing unit 130 is electrically connected to the touchpad 110 and the display unit 120.

The touchpad 110 detects a touch gesture and generates information corresponding to the touch gesture. For example, a user makes a gesture on the touchpad 110, and then the touchpad 110 detects the touch gesture and generates information corresponding to the touch gesture (such as the coordinate data of the finger on the touchpad 110).

The processing unit 130 includes a page display module 131, a gesture processing engine 132, a gestures determining module 133 and a control module 134. The page display module 131 drives the display unit 120 to display a page.

The gesture processing engine 132 determines whether the information corresponding to the touch gesture includes the information that at least three fingers touch the touchpad 110. The gestures determining module 133 determines whether the touchpad 110 detects a scrolling gesture made by one of the three fingers when the information corresponding to the touch gesture includes the information that at least three fingers touch the touchpad 110. The control module 134 scrolls the page or image displayed on the display unit 120 according to the scrolling gesture when the scrolling gesture made by one of the fingers is detected on the touchpad 110.

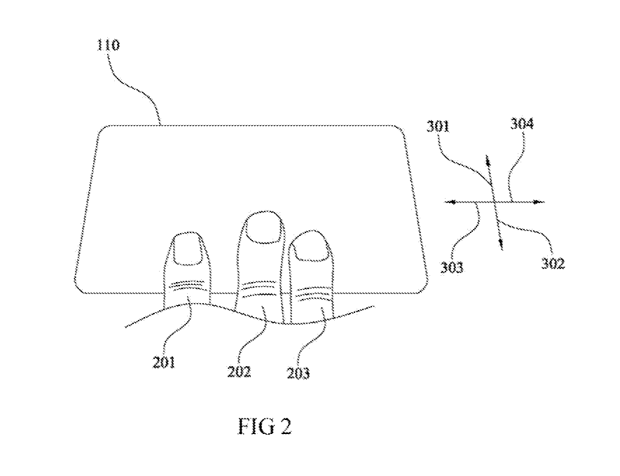

FIG. 2 is an embodiment showing that three fingers operate the touch control device 100 in the embodiment. Users can put three fingers 201, 202, and 203 on the touchpad 110 When operating the touch control device. Then, the touchpad 110 detects the touch of the three fingers 201, 202, and 203, and information corresponding to the touch gesture is generated.

Next, when the gesture processing engine 132 determines the information corresponding to the touch gesture includes the information that at least three fingers 201, 202 and 203 touch the touchpad 110, the gestures determining module 133 determines whether the touchpad 110 detects a scrolling gesture made by one of the three fingers 201, 202 and 203. For example, the finger 201 makes a scrolling gesture, the control module 134 scrolls the page or image displayed on the display unit 120 according to the scrolling gesture of the finger 201. Since the other two fingers 202, 203 support the hand when the finger 201 makes the scrolling gesture, and wrist fatigue is reduced even when the gesture lasts for a long time. In other embodiment, users can use any three fingers or more to make scrolling operation on the touch control device 100, which is not limited herein.

In an embodiment, the control module 134 scrolls the page or image displayed on the display unit 120 according to the direction of the sliding track formed by the scrolling gesture of the user. Consequently the track determining unit 134a of the control module 134 can determine that the direction of the sliding track formed by the scrolling gesture is an upward direction 301, a downward direction 302, a leftward direction 303 or a rightward direction 304. Then, the control module 134 scrolls the page or image displayed on the display unit 120 according to the direction of the sliding track (such as the upward direction 301, the downward direction 302, the leftward direction 303 or the rightward direction 304). The direction of the sliding track also may be defined according to the feature of the display unit, and the scrolling of the page or image displayed on the display unit is based on the direction of the sliding track, which is not limited herein.

In addition, before the gestures determining module 133 operates, the enabling module 135 determines whether the information corresponding to the touch gesture includes the information that all the three fingers 201, 202 and 203 do not move. If the determining result is YES, the gestures determining module 133 is triggered to be enabled. In other words, users can put the three fingers 201, 202 and 203 on the touchpad 110 and stay, and the gestures determining module 133 is started to execute. In this way, the misjudgment of the gestures determining module 133 caused by other touch operation is avoid before the gestures determining module 133 is enabled.

The moving determining module 136 determines the numbers of the fingers 201, 202 and 203 that moves on the touchpad 110. The gestures determining module 113 is triggered to operate when the moving determining module 136 determines only one of the three fingers 201, 202 and 203 moves on the touchpad. Thus, it can avoid the page or image displayed on the display unit 120 is scrolled towards the wrong direction caused by the motion of moving several fingers simultaneously.

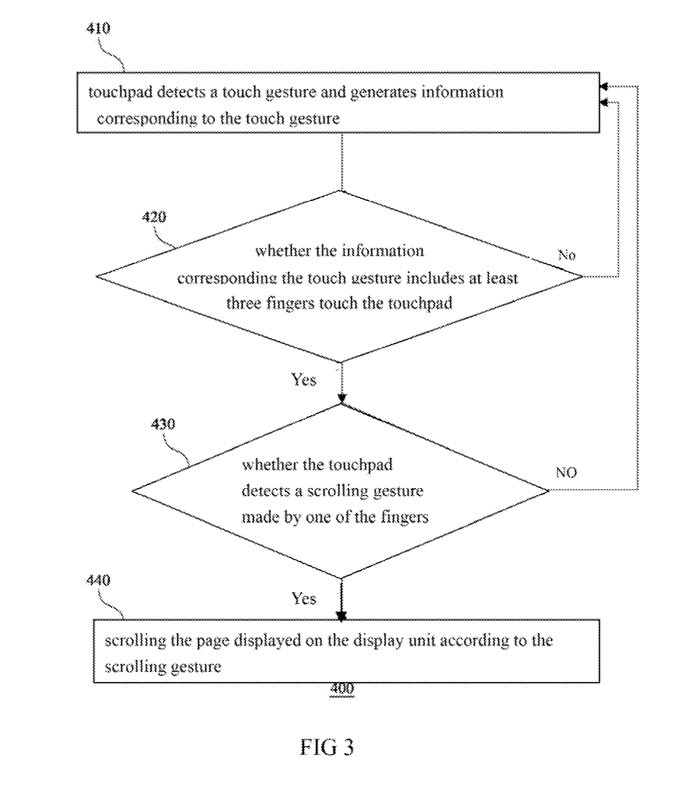

FIG. 3 is a flow diagram showing a touch control processing method applied in a touch control device in an embodiment. The touch control processing method, the touch control device can be touch controlled by three or more fingers. The touch control processing method may be realized by a computer program. The computer program may be stored in a readable recording medium and the computer executes the touch control processing method after reading the recording media. The readable recording medium may be a read-only memory, a flash memory, a floppy disk, a hard disk, a CD-ROM, flash drives, a tape, a database that can be accessed via network or any readable recording medium with the same the function.

The touch control device includes a touchpad and a display unit. The touch control processing method 400 includes the following steps:

In step 410, the touchpad detects a touch gesture and generates information corresponding to the touch gesture. For example, users make a gesture on the touchpad. The touchpad detects the touch gesture and generates information corresponding to the touch gesture. The information corresponding to the touch gesture includes the coordinate data of the touchpad when the touchpad is touched or other information of touch gestures.

In step 420, determining whether the information corresponding to the touch gesture includes at least three fingers touch the touchpad. If the information corresponding to the touch gesture does not include that at least three fingers touch the touchpad, the step 410 is executed.

In step 430, determining whether the touchpad detects a scrolling gesture made by one of the fingers when the information corresponding to the touch gesture includes at least three fingers touch the touchpad. If the touchpad does not detect a scrolling gesture made by at least one of the fingers, the step 410 is executed.

In step 440, scrolling the page or image displayed on the display unit according to the scrolling gesture when the touchpad detects the scrolling gesture is made by one of the fingers.

In an embodiment of the step 440, firstly, determining the direction of the sliding track formed by the scrolling gesture (such as the upward direction, the downward direction, the leftward direction or the rightward direction). Next, scrolling the page or image displayed on the display unit according to the direction of the sliding track.

In addition, before the execution of the step 430, it may include the step of determining whether the information corresponding to the touch gesture includes the information that the at least three fingers do not move. When the information corresponding to the touch gesture includes the information that the at least three fingers do not move, the step 430 is executed. In other words, before scrolling the page or image, users can put at least three fingers on the touchpad and stay to start the execution of the step 430. As a result, it can avoid the misjudgment in step 430 caused by mistouch.

In addition, before the execution of the step 430, determining numbers of fingers that moves on the touchpad. Step 430 is triggered to execute when only one finger of the detected three fingers moves on the touchpad. Thus, it can avoid the page or image is scrolled towards the wrong direction caused by moving multiple fingers simultaneously.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A touch control device, comprising:
a touchpad detecting a touch gesture and generating information corresponding to the touch gesture;
a display unit; and
a processing unit electrically connected to the touchpad and the display unit, wherein the processing unit includes:
a page display nodule driving the display unit to display a page;
a gesture processing engine determining whether the information corresponding to the touch gesture includes the information of at least three fingers touch the touchpad;
a gestures determining module determining whether the touchpad detects a scrolling gesture made by one of the fingers when the information corresponding to the touch gesture includes the information of at least three fingers touch the touchpad; and
a control module scrolling the page or image displayed on the display unit according to the scrolling gesture when the touchpad detects the scrolling gesture made by at least one of the fingers.

2. The touch control device according to claim 1, wherein the processing unit further includes:
an enabling module determining whether the information corresponding to the touch gesture includes the information that the at least three fingers do not move before the gestures determining module operates,
wherein the gestures determining module is triggered to execute when the information corresponding to the touch gesture includes the information that the at least three fingers do not move.

3. The touch control device according to claim 1, wherein the processing unit further includes:
a moving determining module determining whether only one of the at least three fingers moves on the touchpad;
wherein the gestures determining module is triggered to execute when the moving determining module determines only one of the at least three fingers moves on the touchpad.

4. The ouch control device according to claim 1, wherein the control module further includes:
a track determining unit determining the direction of the sliding track formed by the scrolling gesture, wherein the control module scrolls the page or image displayed on the display unit according to the direction of the sliding track.

5. The touch control device according to claim 4, wherein the direction of the sliding track is upward, downward, leftward or rightward.

6. A touch control processing method, applied to a touch control device, wherein the touch control device comprises a touchpad and a display unit, the touch control processing method comprising:
(a) detecting a touch gesture via the touchpad and generating information corresponding to the touch gesture;
(b) determining whether the information corresponding to the touch gesture includes at least three fingers touch the touchpad;
(c) determining whether the touchpad detects a scrolling gesture made by one of the fingers when the information corresponding to the touch gesture includes the at least three fingers touch the touchpad; and
(d) scrolling the page or image displayed on the display unit according to the scrolling gesture when the touchpad detects the scrolling gesture made by one of the at least three fingers.

7. The touch control processing method according to claim 6, further comprising:
determining whether the information corresponding to the touch gesture includes the information that the at least three fingers do not move before the execution of the step (c); and
triggering step (c) to execute when the information corresponding to the touch gesture includes the information that the at least three fingers do not move.

8. The touch control processing method according to claim 6, further comprising:
determining whether only one of the three fingers moves on the touchpad before the execution of the step (c), and
triggering step (c) to execute when only one of the three fingers moves on the touchpad.

9. The touch control processing method according to claim 6, wherein the step (d) further includes:
determining the direction of the sliding track formed by the scrolling gesture; and
scrolling the page or image displayed on the display unit according to the direction of the sliding track.

10. The touch control processing method according to claim 9, wherein the direction of the sliding track is upward, downward, leftward or rightward.
